(19) United States
(12) Patent Application Publication
(10) Pub. No.: US 2014/0164296 A1
(43) Pub. Date: Jun. 12, 2014

(54) CHATBOT SYSTEM AND METHOD WITH ENTITY-RELEVANT CONTENT FROM ENTITY

(71) Applicant: Xiaojiang Duan, Chaoyang District (CN)

(72) Inventor: Xiaojiang Duan, Chaoyang District (CN)

(21) Appl. No.: 13/711,179

(22) Filed: Dec. 11, 2012

(51) Int. Cl. G06N 5/04

(52) U.S. Cl. CPC G06N 5/047
USPC 706/11

(57) ABSTRACT

A chatbot system and method with entity-relevant content from entity. An administrator creates preliminary chatbot content including questions as well as patterns for the questions. The questions are answered by an entity account holder or other associate. The question and answer pairs are stored as input/output chatbot message pairs in a knowledge base and become chatbot content for future chatbot use.

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods and more specifically to chatbot systems and methods for generating chatbot content.

Chatbot computer programs are designed to simulate intelligent conversation with one or more human users via auditory or textual methods. Chatbots are often integrated into interactive dialogs for various practical purposes such as personalized service or information acquisition.

Chatbot content, including user questions (input messages) and chatbot responses (output messages) that might be communicated during a chat session, is often stored or preprogrammed into the chatbot. For example, an input/output chatbot message pair might be:

User: Are you a female bot?

Chatbot: Yes. Are you a girl?

This collection of chatbot content is known as a knowledge base. The more comprehensive the knowledge base is, the more proficient the chatbot is. Preliminarily, an administrator or owner of the chatbot provides as much chatbot content as possible in the knowledge base. Specifically, the administrator attempts to formulate questions/input messages that might be asked by future users. Similarly, output messages or responses by the chatbot to such user questions are also formulated and stored along with the corresponding questions.

The administrator usually predicts a limited number of user input/output chatbot message pairs for the knowledge base because of the myriad ways in which actual user communication can occur. At other times, the administrator can predict a user input message but is unable to formulate an adequate chatbot output message. In other instances, the administrator predicts input/output chatbot message pairs that are of general applicability since the administrator is unaware of specific entities that will employ the chatbot at the time the input/output chatbot message pairs are created.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a chatbot system and method for creating entity-relevant content can be found in exemplary embodiments of the present invention.

In a first embodiment of the present method, an administrator creates preliminary content for the chatbot. This preliminary content might include questions as well as patterns for the questions. Each question corresponds one or more patterns that can identify that particular question. Here, the chatbot and its preliminary content might be deployed on an entity's website to communicate with website users about the entity.

The patterns for each question are then used to determine whether the question is relevant to the entity. In one embodiment, the patterns are matched with a sentence on the entity website to determine relevancy. If relevant, the question is then presented for display so that an entity chatbot account holder can respond to the question. Once answered, the question and response are stored as chatbot content for use by website users to communicate with the chatbot.

In this manner, inadequate chatbot output messages need not be formulated by an administrator since the entity account holder answers all of the questions, thus providing chatbot output messages for future use. Moreover, the input/output chatbot message pairs that are generated and stored after the entity account holder answers the relevant questions are specifically adapted to the entity or entity website since the content is being provided by the account holder who is knowledgeable about the website or entity for which the chatbot is being published.

In a further embodiment, the system for creating content for the chatbot is disclosed. The system uses an interactive display and a computer system capable of processing one or more lines of code. The system includes one or more lines of code instructions that display questions pertaining to the entity. The system also includes one or more lines of code instructions that receive an answer to each question and stores each question and answer pair as chatbot content for use by future website users and the chatbot.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a chatbot communication system according to an exemplary embodiment of the present invention.

FIG. 2 illustrates a chatbot dialog interface of the chatbot system of FIG. 1 in accordance with an exemplary embodiment of the present invention.

FIG. 3 illustrates a list of chatbot preliminary questions prepared by a chatbot administrator for an entity website according to an exemplary embodiment of the present invention.

FIG. 4 illustrates a crawler that determines the relevance of preliminary questions formulated by an administrator according to an exemplary embodiment of the present invention.

FIG. 5 illustrates a chatbot dialog interface receiving and displaying relevant questions to an account holder according to an exemplary embodiment of the present invention.

6A shows a typical computer such as would be operated by a user on the Internet and suitably programmed using one or more lines of code to execute embodiments of the present invention.

FIG. 6B shows subsystems of the computer of FIG. 6A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

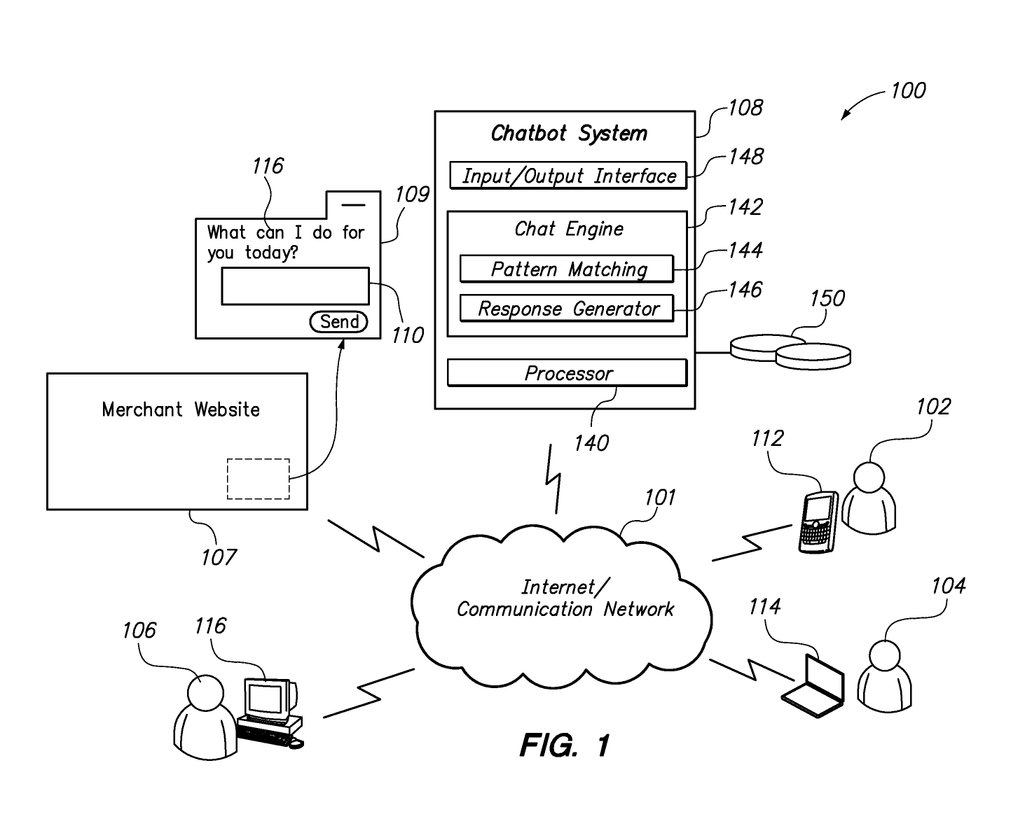

FIG. 1 illustrates chatbot communication system 100 according to an exemplary embodiment of the present invention.

In FIG. 1, chatbot communication system 100 comprises user 102 communicably coupled to chatbot system 108 via Internet/communication network 101. User 102 represents a customer visiting a website over Internet 101 to commence a chat session with chatbot system 108.

Internet 101 represents any distributed network (wired, wireless or otherwise) for data transmission and receipt between/among two or more points. In some embodiments, chatbot system 108 includes a graphical image including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) that displays chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents any entity or merchant that owns, manages or operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, in one embodiment, after installing chatbot dialog interface 116 and logging into the chatbot system, a list (not shown) of potential user questions that are relevant to merchant website 107 is displayed for viewing and for response by merchant 106. Since merchant 106 operates the website and/or runs the entity associated with the website, merchant 106 is best positioned to respond to such potential user questions as further described with reference to FIGS. 3-5.

This relevant list of potential user questions is displayed on chatbot dialog interface 116, which is then used by merchant 106 to answer all of the relevant questions. Any associate of merchant 106 or other entity that is running or affiliated with the website can also answer the questions so long as the associate is sufficiently knowledgeable about the entity to answer such questions. The answers or responses provided by merchant 106 and their corresponding questions thus become part of the chatbot knowledge base. In this manner, an embodiment of the present invention is able to adapt and create additional chatbot content relevant to a specific entity such as merchant 106 or merchant website 107.

In a further embodiment, after all of the relevant questions are answered and a chat session is initiated, merchant 106 can then train chatbot system 108 to add or modify the existing chatbot content by using a predetermined unique identifier in dialog box 110 of chatbot dialog interface 116 to as further discussed in “User-Aided Chatbot Learning System And Method,” U.S. patent application Ser. No. 13/661,034, filed Oct. 26, 2012, the specification of which is incorporated by reference as if fully set forth here.

In FIG. 1, chatbot system 108 can respond to an input message from the user by displaying an output message via output display 109 above dialog box 110. The initial “input message” is the user's action of browsing to merchant website 107 having chatbot system 108. Following this initial “input message”, an output message “What can I do for you today?” is displayed by output display 109. Note that this is a special output message called an initial or opening message. After this special output message is displayed, the user can then subsequently ask questions or communicate with chatbot system 108 by entering the questions in dialog box 110.

Chatbot messages are generated by chatbot system 108 by querying the input message from users in a knowledge base according to a certain set of rules. Chatbot system 108 includes a graphical image representing chatbot dialog interface 116, the graphical image including, without limitation, an avatar, a talking head, a text-to-speech engine, etc. In some embodiments, users 102, 104 and/or 106 may enter input messages to chatbot system 108 with a keyboard, mouse, and a visual recognition device.

In FIG. 1, chatbot system 108 includes input/output interface 148 for entering and displaying messages to and from users 102, 104, 106. Chatbot system 108 also includes crawler 154 for parsing web pages, specifically here, for parsing pages of merchant website 107 to determine if the user questions are relevant to merchant 106 and/or merchant website 107 as further described with reference to FIGS. 3-5.

In FIG. 1, chatbot system 108 also includes chat engine 142 that receives an input message from dialog box 110 and processes the input message by pairing or associating the input message with an appropriate chatbot message. Note that, conveniently, one or more components of chatbot system 108 may be conveniently referred to as chatbot system 108.

Chat engine 142 in conjunction with processor 140 utilizes pattern matching engine 144 to recognize appropriate responses for input messages. In one embodiment, pattern matching engine 144 employs AIML (Artificial Intelligence Markup Language), which is an XML (Extensible Markup Language) dialect. Note that AIML implementation is but an embodiment of the present invention; implementations utilizing other languages are employed as well. Here, AIML comprises several elements. A first element is category, which is a fundamental unit of knowledge. A category includes two or more elements (e.g. pattern and template).

```
<category>
  <pattern>WHAT IS YOUR NAME</pattern>
  <template>My name is Eddy.</template>
</category>
```

When this category is loaded, a chatbot receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc.

A template provides the response for a pattern. An example of a template is “My name is Eddy.” A template can also use variables. A template may be as simple as some literal text, like “My name is <bot name=“name”/>,” which substitutes the chatbot's name into the sentence, or “You said you are <get name=“userage”/>years of age,” in which the user's age is replaced in the sentence.

Text formatting, conditional response (if then/else), and random responses are elements of templates. Templates can also use the srai element to redirect to another pattern.

```
<category>
    <pattern>What is your name</pattern>
    <template>My name is <bot name=“name”></template>
</category>
<category>
    <pattern>WHAT IS YOUR GIVEN NAME</pattern>
      <template>
      <srai>What is your name</srai>
    </template>
</category>
```

In the first category, the input “What is your name” receives the chatbot's name as a response. In the second category, the input “WHAT IS YOUR GIVEN NAME” is redirected to the category that matches the input “What is your name.” In essence, the two phrases are equivalent. Templates may include other content types that are processed by the chatbot user interface. As an example, a template may employ HTML (Hyper-Text Markup Language) tags for formatting. Clients not supporting HTML typically ignore the tag.

Those skilled in the art will recognize that other techniques that can either substitute or supplement pattern matching engine 144 can be employed. After pattern matching engine 144 recognizes appropriate responses for input messages, pattern matching engine 144 then passes the chatbot message to response generator 146, which generates an appropriate response.

In FIG. 1, in one embodiment, knowledge database 150 may receive and store input messages and user-generated messages including the context for such messages, the messages being received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or components as needed to implement the present invention.

Briefly, in operation, merchant 106 initially answers a list of questions from chatbot system 108, the list of questions being relevant to merchant website 107. The answers and corresponding relevant questions are then added to the chatbot knowledge base. Thereafter, in one embodiment, merchant 106 can train chatbot system 108 to provide modified chatbot messages that are displayed by output display 109 of chatbot dialog interface 116.

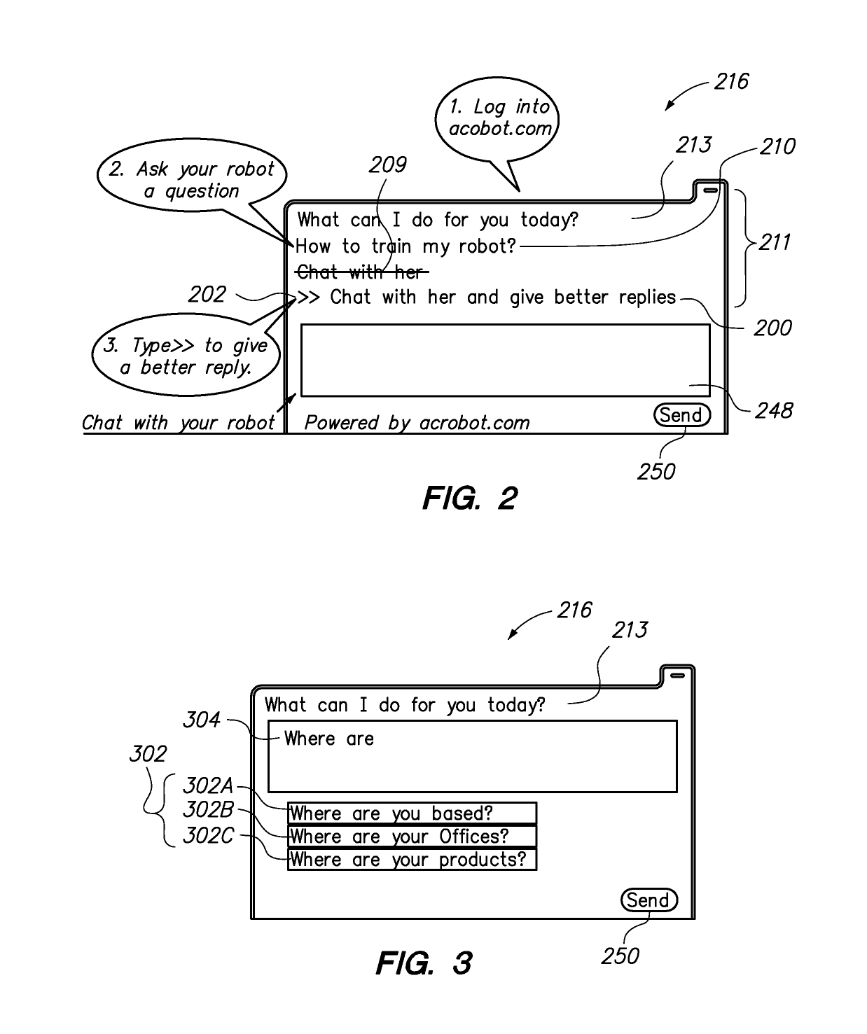

FIG. 2 illustrates chatbot dialog interface 216 of chatbot system 108 (FIG. 1) in accordance with an exemplary embodiment of the present invention.

In FIG. 2, chatbot dialog interface 216 includes an interface with two main areas, namely dialog box 248 and output display 211 that function in the same manner as corresponding components in chatbot dialog interface 116 of FIG. 1. User messages entered via dialog box 248 are displayed in output display 211. Chatbot messages generated by chatbot system 108 are displayed via output display 211.

After installation of chatbot system 108, merchant 106 then logs onto the chatbot user account for the first time. Upon initial logon, chatbot system 108 displays a relevant list of questions on chatbot dialog interface 216 and requests responses from merchant 106. The relevant list of questions includes questions that have been determined to be relevant to the merchant or entity's business or website. As noted, such relevant questions are displayed to merchant 106 or any other individual, administrator or associate who operates the website in which chatbot system 108 is operable.

Upon display of the relevant user questions, merchant 106 then uses dialog box 248 to provide answers/corresponding responses to the questions. Once each relevant question is answered, the relevant question and response message pair are stored as chatbot content for future use.

In FIG. 2, as can be seen, one of the relevant questions presented to merchant 106 is “Do you provide phone support?” 203 that is displayed within output display 211. Responsive thereof, merchant 106 can utilize dialog box 248 to enter a responsive message to “Do you provide phone support?” 203 and then select send button 250 to submit the response. The question and responsive message pair are thereafter stored in a knowledge base for future use. End users and customers of merchant 106 can then communicate with chatbot system 108 based on the stored question and answer message pairs.

FIG. 3 illustrates table 300 according to an exemplary embodiment of the present invention.

In FIG. 3, table 300 shows preliminary questions 304 prepared by chatbot administrator 302 for an entity website (e.g., merchant website 107 of FIG. 1). Preliminary questions 304 are a prediction by chatbot administrator 302 of questions that might be asked by users of merchant website 107.

For example, “Do you provide phone support?” 304A is a question that a user of merchant website 107 may wish to ask. Users are interested in knowing whether products or services offered by merchant website 107 can be supported by the merchant. One skilled in the art will realize that preliminary questions 304 are for illustration purposes and questions displayed may vary based on the website or business to which the questions are adapted.

In FIG. 3, table 300 also shows web text patterns 306 corresponding to preliminary questions 304. The web text patterns are also prepared by administrator 302. Each preliminary question has one or more corresponding web text patterns for determining whether the preliminary question is relevant to a specific website. For example, preliminary question “Do you provide phone support?” 304A has corresponding web text pattern 306A that can identify whether preliminary question 304A is relevant to merchant website 107. Note also that a web text pattern(s) can correspond to a group of questions.

Preliminary questions 304 include questions that may or may not be relevant to merchant website 107. Thus, the relevant ones of the preliminary questions 304 are first determined and the irrelevant questions are discarded. The resulting relevant questions are then displayed to merchant 106 or an entity account holder or any owner or operator of merchant website 107 that can answer the relevant questions. Once answered, the questions and answers are stored as chatbot content namely input/output chatbot message pairs for future use by users of merchant website 107.

Referring now to FIG. 3, administrator 302 has formulated preliminary question “Do you provide phone support?” 304A and provided its corresponding web text pattern “Phone support” 306A. A follow-up preliminary question “What is your support phone number?” 304B having web text pattern “Support phone number” 306B has also been predicted. Each preliminary question and follow-up question, if any, is presented sequentially to merchant 106 in an order that makes logical sense.

Note also that follow-up preliminary question “What is your support phone number?” 304B is relevant only if preliminary question “Do you provide phone support?” 304A is relevant to merchant website 107. Thus, if preliminary question “Do you provide phone support?” 304A is irrelevant, both questions 304A and 304B are discarded and merchant 106 is not requested to provide answers.

Thus, here, administrator 302 prepares preliminary questions 304 not knowing with certainty whether they are relevant to merchant website 107. Administrator 302, however, provides web text patterns 306 that can be used to make that relevancy determination.

Referring now to FIG. 3, administrator 302 has also predicted preliminary question “Do you have a refund policy?” 304D having corresponding web text pattern “Refund policy” 306D that is used to determine whether preliminary question 304D is relevant. Follow-up question “What are the conditions for obtaining a refund?” 304E and its corresponding web text pattern “Refund condition” 306E are also shown in table 300.

In table 300 of FIG. 3, administrator 302 has also predicted preliminary question “Do you guarantee your products?” 304J and its corresponding web text pattern 306J. Here, administrator 302 has reasoned that many users, clients or customers of merchant 106 are interested in knowing whether or not products or services that are procured are guaranteed by merchant 106. Thus, administrator 302 has preliminary question “Do you guarantee your products?” 304J in table 300 as possible chatbot content. Follow-up preliminary question “How long is your product guaranteed?” 304K and its associated web text pattern “Money back guarantee” 306K are also shown in table 300.

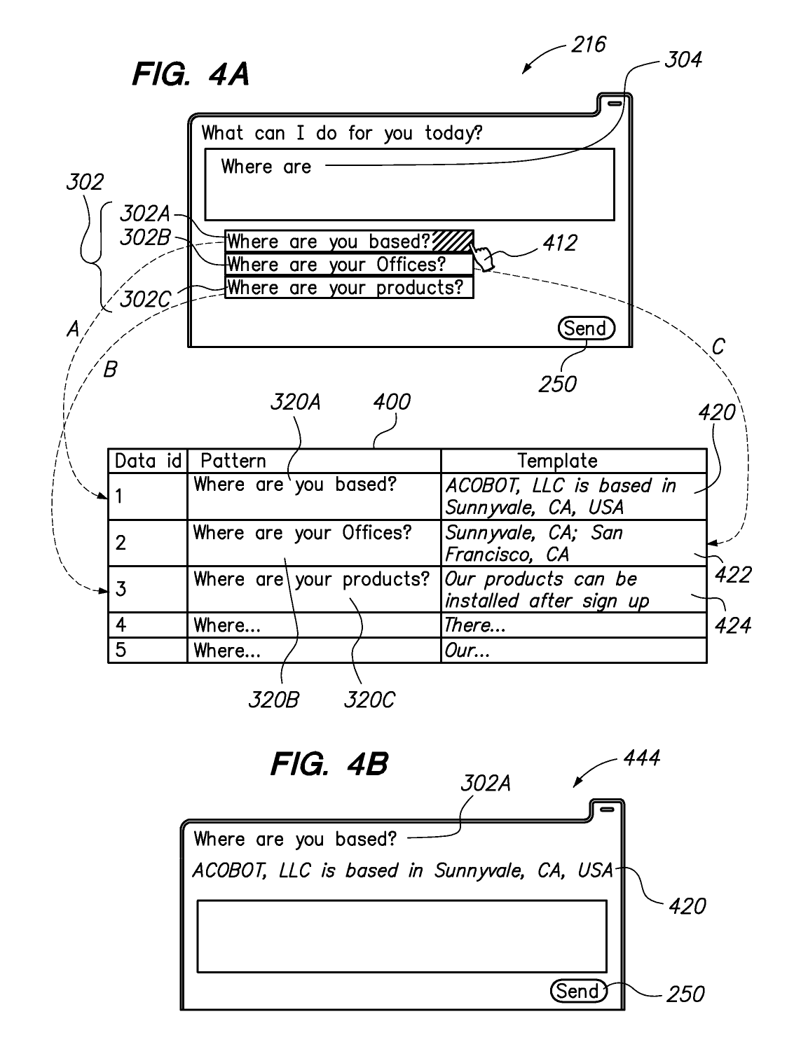

FIG. 4 illustrates crawler 154 of chatbot system 108 of FIG. 1 crawling merchant website 407 so that chatbot system 108 can determine the relevancy of preliminary questions formulated by an administrator according to an exemplary embodiment of the present invention.

In FIG. 4, in summary, crawler 154 crawls merchant website 407 in order to obtain the web pages of merchant website 407. Here, a single web page 408 has been obtained from merchant website 407. Although not shown, the merchant website can include a plurality of web pages and additional links linking the plurality of web pages to web pages on other web sites. Web page 408 is also exemplary and can differ from the illustration of FIG. 4.

After crawler 154 obtains web page 408, chatbot system 108 then uses web text patterns 306 of table 300 to determine whether preliminary questions 304 are relevant to merchant website 407 (based on web page 408). For example, chatbot 108 employs web text pattern “phone support” 306A to determine whether preliminary question “Do you provide phone support” 304A is relevant to merchant website 407 (or merchant 106's business). Specifically, chatbot system 108 parses web page 408 into one or more segments 409, each segment 409 being examined to determine if it matches a web text pattern 306. If a match exists between a web text pattern 306 and any segment 409, then the preliminary question 404 associated with the web text pattern 306 is relevant to merchant website 407.

In more detail, chatbot system 108 uses web text patterns 306 of table 300 to determine the relevancy of corresponding preliminary questions 304 to merchant website 407. For example, chatbot system 108 employs web text pattern “phone support” 306A to determine whether preliminary question “Do you provide phone support” 304A is relevant to merchant website 407 (or merchant 106's business).

Additional examples are shown in table 300 of FIG. 3. Thus, chatbot system 108 uses web text pattern “Support phone number” 306B to determine whether preliminary question “What is your support phone number?” 304B is relevant to merchant website 407 or merchant 106's business. Chatbot system 108 uses web text pattern “Refund policy” 306C to determine relevancy of preliminary question “Do you have a refund policy?”304C. Web text pattern “Refund condition” 306D is used to determine relevancy for preliminary question “What are the conditions for obtaining a refund?” 304D. Web text pattern “Guarantee” 306E is used for preliminary question “Do you guarantee your products?” 304E and web text pattern “Money back guarantee” 306F is used for determining relevancy of preliminary question “How long is your product guaranteed?” 304F.

Here, chatbot system 108 determines relevancy by match each of web text patterns 306 with segments of web page 408. Initially, upon registration for a chatbot account, merchant 106 is required to provide a home page URL (Uniform Resource Locator) for merchant website 407, wherein chatbot system 108 is to be published. Here, merchant 106 has provided URL http://www.business.com/viewsource 415, as the home page (web page 408) for merchant website 407.

Upon receiving URL 415, crawler 154 begins to crawl merchant website 407 to obtain web page 408. Here, in one embodiment, crawler 154 may be any conventional crawler software modified as necessary to implement the present invention. Crawler 154 can read web pages based on a given URL, extract the URLs from web page content, and locate sub-pages by reading web pages and extracting URLs recursively.

Chatbot system 108 parses web page 408 into one or more segments 409 in sequence. A segment contains a grammatical sentence or a text string separated by HTML elements such as <p>. In FIG. 4, segment 409 is defined by opening and closing HTML tags; segment 409 is shown as “<meta content=“We are proud to support our customers by offering 24 hour phone support and more!” name=“description”/>”. Although not shown, one of ordinary skill in the art will realize that merchant website 407 includes a plurality of segments.

After web page 408 is segmented, the segments and web text patterns 306 are compared to determine whether a match exists. Here, for example, web text pattern “Phone support” 306A is compared with segment 409 to determine if a match exists, that is, whether the pattern or keywords “phone support” are locatable within segment 409. Here, a match exists because the pattern “phone support” is locatable in segment 409 “<meta content=“We are proud to support our customers by offering 24 hour phone support and more!” name=“description”/>”. Thus, preliminary question “Do you provide phone support?” 304A is relevant to merchant website 407.

Similarly, preliminary question “What is your support phone number?” 304B is relevant based on web text pattern “Support phone number” 306 and segment 410. Preliminary question “Do you have a refund policy?”304C is relevant based on web text pattern “Refund policy” 306C and segment 411. Preliminary question “What are the conditions for obtaining a refund?” 304D is relevant based on web text pattern “Refund condition” 306D and segment 412.

However, preliminary question “Do you guarantee your products?” 304E is not relevant because no web page segments can be found on web page 408 of merchant website 407 with web text pattern “Guarantee” 306E. Preliminary question “How long is your product guaranteed?” 304F is also irrelevant since web text pattern “Money back guarantee” 306F cannot be found in any segment. The preceding examples are for illustration purposes, and one of ordinary skill in the art will realize that there are myriad of ways for implementing pattern matching that are within the spirit and scope of the present invention.

Although not shown, a preliminary question may also be relevant if any website segment matches one of the given patterns such as an AIML pattern and/or a regular expression. A regular expression is a character set that specifies a pattern.

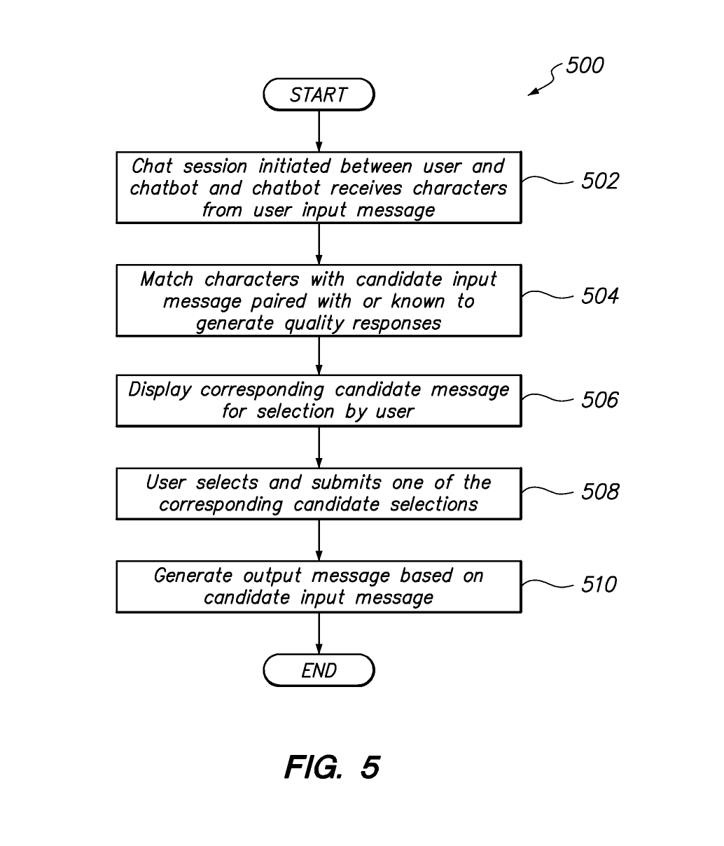

After determining that a match exists between web text patterns and segments, some preliminary questions are now known to be relevant to merchant website 407. The resulting relevant questions 404 are then added to a queue 504 (FIG. 5) for display to merchant 106 or any individual best positioned to answer the questions in the queue.

In FIG. 4, as can be seen, relevant questions 404 include only four of six preliminary questions 304 that have been determined to be relevant. The relevant questions 404: “Do you provide phone support?” 304A; “What is your support phone number?” 304B; “Do you have a refund policy?”304C; and “What are the conditions for obtaining a refund?” 304D. Note here that administrator 302 sorts relevant questions 404 in a group based on their logic relationship. Thus, questions 304A and 304B of relevant questions 404 are chronological as they are related. Relevant questions 304C and 304D are also logically grouped.

Preliminary question “Do you guarantee your products?” 304E and preliminary question “How long is your product guaranteed?” 304F are irrelevant and are discarded. They are not queued or presented to merchant 106 for responses.

FIG. 5 illustrates chatbot dialog interface 216 receiving and displaying relevant questions to an account holder according to an exemplary embodiment of the present invention.

In FIG. 5, specifically, chatbot dialog interface 216 receives and displays from relevant questions queue 504 as shown. This queue is stacked with the four questions that are relevant to merchant website 407 as discussed in FIG. 4. Once displayed, the relevant questions are answered by an account holder, owner or any other individual that is associated with the website or entity for which chatbot system 108 is being operated, said individual being able to answer the questions presented.

As shown, relevant questions queue 504 comprises the four relevant questions (404 of FIG. 4) namely “Do you provide phone support?” 304A, “What is your support phone number?” 304B, “Do you have a refund policy” 304C and “What are the conditions for obtaining a refund? 304D. Note that chatbot system 108 ensures that only unique questions are added to the queue.

Each question is sent in sequence from relevant questions queue 504 to output display 211 of chatbot dialog interface 216. Note that in queue 504, the logical order of the questions is maintained. This order is also maintained when the questions are displayed by output display 211.

Thus, as shown, the first question that is sent from relevant questions queue 504 for display is “Do you provide phone support?” 304A followed by “What is your support phone number?” 304B. This order is logical as it makes no sense to ask for a phone number when it is not known whether merchant 106 provides phone support services. “Do you have a refund policy” 304C is displayed next followed by “What are the conditions for obtaining a refund? 304D.

As the questions are displayed, merchant 106 (FIG. 1) can then respond to the relevant questions. Once a relevant question is answered, it is removed from the queue. For example, in FIG. 5, “Do you provide phone support?” 304A has been displayed by chatbot dialog interface 216. In response, merchant 106 has entered “Yes, we provide phone support to all our customers” 520. Thus, question “Do you provide phone support?” 304A is removed from relevant questions queue 504 since it has been answered. Contrawise, if a question remains unanswered, it is simply returned to the queue.

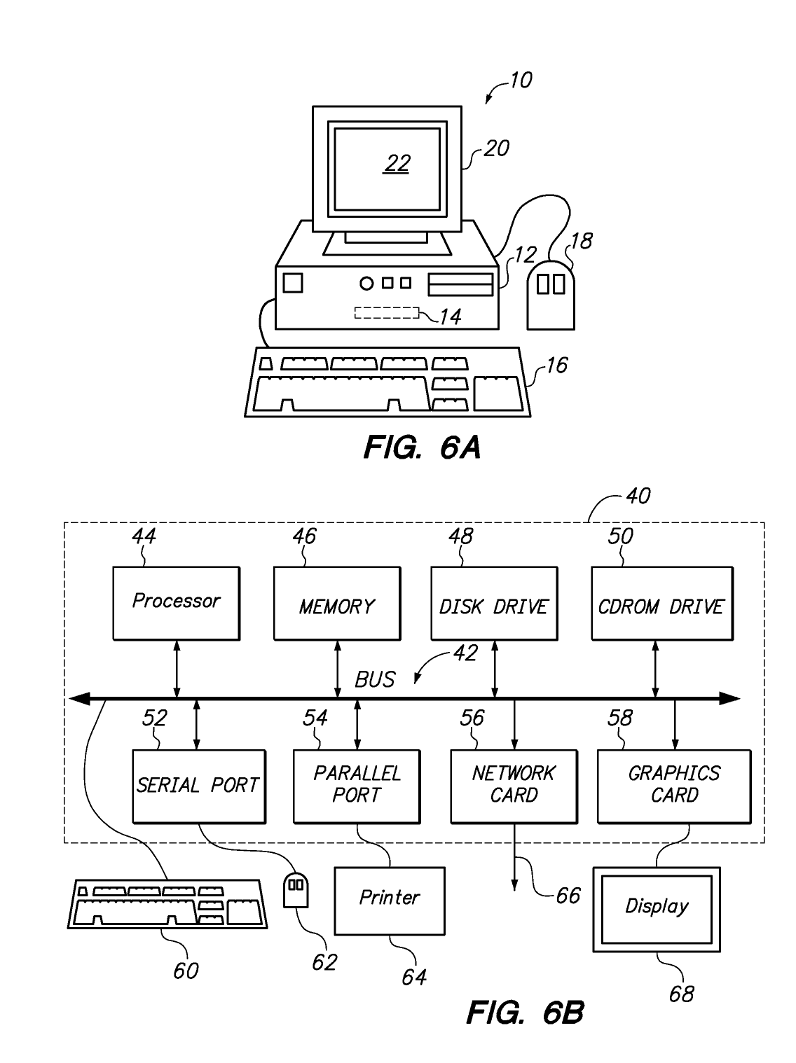

FIG. 6A shows a typical computer 10 such as would be operated by a user on the Internet and suitably programmed using one or more lines of code to execute embodiments of the present invention. Computer 10 includes a cabinet 12 housing familiar computer components such as a processor, memory, disk drive, Compact Digital Read-Only Memory (CDROM), etc. User input devices include keyboard 16 and mouse 18. Output devices include display 20 having a display screen 22. Naturally, many other configurations of a computer system are possible. Some computer systems may other components in addition to those shown in FIG. 6A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 6A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 6A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 6B shows subsystems of the computer of FIG. 6A. In FIG. 6B, subsystems within box 40 are internal to, for example, the cabinet 12 of FIG. 6A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 6B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, operable by a chatbot, for creating content for the chatbot, wherein an administrator creates preliminary content for the chatbot, said preliminary content comprising questions and corresponding patterns, each question corresponding to one or more patterns that can identify the question, wherein the chatbot and its preliminary content is deployable on an entity's website to communicate with website users about said entity, the method comprising:
using the pattern associated with each question to determine whether said question is relevant to the entity by matching the pattern with one or more sentences identifiable on the entity website, wherein a question is relevant to said entity if said pattern associated with said question matches at least one identifiable sentence;
if a question is determined to be relevant, displaying each relevant question so that an entity account holder or other associate of the entity can respond to each of said relevant questions; and
accepting a response for each of said relevant questions and storing each relevant question and corresponding response as chatbot content for use by said website users communicating with said chatbot.

2. The method of claim 1 further comprising placing the relevant questions in a queue and displaying each relevant question to the associate one after the other.

3. The method of claim 2 further comprising removing each relevant question from said queue once the question is answered.

4. A method, operable by a chatbot, for creating content for the chatbot, wherein the content comprises both questions about an entity and answers responding to the questions about said entity, wherein each question has a corresponding pattern, wherein both said question and corresponding pattern are prepared for the chatbot by a chatbot administrator and wherein the chatbot is operable on the entity website to interact with website users, the method comprising:
displaying questions that are relevant to said entity, said relevant questions being displayed on an interactive user interface for viewing and for receiving entity responses to the relevant questions; and
receiving an answer to each relevant question and storing each relevant question and corresponding answer as chatbot content for use by said website users communicating with said chatbot.

5. The method of claim 4 further comprising prior to said displaying questions that are relevant, determining whether each of said questions is relevant to the entity by segmenting the website into sentences.

6. The method of claim 5 further comprising matching the sentences with patterns associated with said questions, wherein a question is relevant if the pattern associated with said question corresponds to any one or more of the sentences.

7. The method of claim 4 further comprising adding the relevant questions to a queue for display to an entity account holder or other associate that can answer said questions.

8. The method of claim 4 further comprising removing the answered question from said queue when each relevant question is answered.

9. The method of claim 4 further comprising displaying said questions that are relevant in a logical order based on relationships between the questions.

10. A system for creating content for the chatbot, wherein the content comprises both questions about an entity and answers responding to the questions about said entity, wherein each question has a corresponding pattern, wherein the chatbot is operable on the entity website to interact with website users, the system being operable to use an interactive display and a computer system capable of processing one or more lines of code, the system comprising:
one or more lines of code instructions that display questions pertaining to said entity, said questions being displayed on an interactive user interface for viewing and for providing responses to the questions; and
one or more lines of code instructions that receive an answer to each question and storing each relevant question and corresponding answer as chatbot content for use by said website users communicating with said chatbot.

11. The system of claim 10 further comprising one or more lines of code instruction that determine whether each of said questions is relevant to the entity by segmenting the website into sentences.

12. The system of claim 11 further comprising one or more lines of code instruction that match the sentences with patterns associated with said questions, wherein a question is relevant if the pattern associated with said question corresponds to any one or more of the sentences.

13. The system of claim 10 further comprising one or more lines of code instruction that add said questions to a queue for display to said user.

14. The system of claim 10 further comprising one or more lines of code instructions that remove the answered question from said queue when each question is answered.

15. The system of claim 10 further comprising one or more lines of code that display said questions in a logical order based on relationships between the questions.
